(19) United States
(12) Patent Application Publication
(10) Pub. No.: US 2017/0173945 A1
(43) Pub. Date: Jun. 22, 2017

(54) Apparatus for Jetting Fine Liquid Drop and Method Therefor

(71) Applicant: Enjet Co., Ltd., Suwon-si (KR)

(72) Inventors: Do Young Byun, Seoul (KR); Vu Dat Nguyen, Yeongtong-gu (KR)

(21) Appl. No.: 15/371,546

(22) Filed: Dec. 7, 2016

(30) Foreign Application Priority Data
Dec. 17, 2015 (KR) 10-2015-0181309

(51) Int. Cl. B41J 2/045

(52) U.S. Cl. CPC B41J 2/04548; B41J 2/04581

(57) ABSTRACT

An ink jetting apparatus and method capable of jetting fine liquid drops is disclosed, according to one aspect of an embodiment, the ink jetting apparatus including a chamber for accommodating ink and a jetting unit for jetting ink, the ink jetting apparatus including a pressurizing unit configured to form a meniscus at a tip of the jetting unit by pressurizing the ink contained in the chamber; and a vibrating unit configured to excite and decompose the meniscus formed at the tip of the jetting unit by vibrating the jetting unit.

### CROSS-REFERENCE TO RELATED APPLICATION

This application claims the benefit of priority under 35 U.S.C. §119(a) of Korean Patent Application No. 10-2015-0181309, filed on Dec. 17, 2015, in the Korean Intellectual Property Office, the entire disclosure of which is incorporated herein by reference for all purposes.

### BACKGROUND

Field

The present disclosure relates to an apparatus and method for jetting fine liquid drops, and more particularly, to an apparatus and method for jetting a fine liquid drop by exciting a meniscus formed at a tip of a jetting unit using ultrasonic vibration to decompose the meniscus, thereby jetting a fine liquid drop without having to reduce a diameter of the jetting unit.

Description of Related Art

The contents disclosed hereinbelow merely provide background information of the present disclosure, not information on conventional art.

In general, an ink jetting apparatus configured to jet fluid in the form of liquid drops used to be applied to inkjet printers, but in recent days, ink jetting apparatuses are widely applied to high-tech industrial areas such as display manufacturing process, printed circuit board manufacturing process, DNA chip manufacturing process and the like. Especially, as the patents for 3D printers are expiring, the ink jetting apparatus technology is expected to be applied to the 3D printer area.

An ink jetting apparatus is an apparatus configured to jet liquid drops from ink that is in a liquid state. Ink jetting apparatuses are classified into thermal type ink jetting apparatuses and piezoelectric type ink jetting apparatuses depending on the method used for jetting the liquid drops.

A thermal type ink jetting apparatus heats a nozzle so that the ink inside the nozzle boils momentarily, and uses water vapor pressure to push the ink. The thermal type ink jetting apparatus has a disadvantage that it may be affected by chemical properties of the ink, but also an advantage that the price is inexpensive.

A piezoelectric type ink jetting apparatus is provided with a piezoelectric element (piezo element) attached to a rear surface of a nozzle. This is a type of ink jetting apparatus where, as a voltage is applied to the piezoelectric element, the plate of the piezoelectric element bends, thus pushing the ink. The piezoelectric type ink jetting apparatus has a disadvantage that the price is expensive, but also advantages that it is easy to adjust the voltage, frequency, velocity and the like, and that it is not significantly affected by the chemical properties of the ink.

Thermal and piezoelectric type ink jetting apparatuses are known to have difficulties in separating liquid drops from ink having a viscosity of 50 cP or above, and in jetting liquid drops each having a diameter of 20 um or below.

In order to overcome such limitations of the existing methods, a hybrid method for controlling the liquid surface using a physical control apparatus such as the piezoelectric element or the like and jetting liquid drops using electrostatic force is being proposed.

Examples of such a hybrid type ink jetting apparatus disclosed include a ‘HYBRID TYPE INK JET PRINT HEAD’ (Korean patent laid-open no. 2010-0128953, published on Dec. 8, 2010), and a ‘HYBRID-TYPE APPARATUS FOR INJECTING INK’ (Korean patent laid-open no. 2014-0059013, published on May 15, 2014).

Korean patent laid-open no. 2010-0128953 discloses a hybrid type inkjet print head where an electrode having a certain shape and a piezoelectric actuator facilitates generation of a meniscus, thereby reducing the energy required compared to a conventional ESD type inkjet print head.

Korean patent laid-open no. 2014-0059013 discloses a hybrid type ink jetting apparatus where a physical driving unit is arranged in an opened upper portion of a nozzle, so that the physical driving unit may be driven by an electrode provided at an upper side and a lower side of the nozzle while at the same time an electric field is formed, thereby easily jetting ink having a fine diameter.

### SUMMARY

Therefore, for a generally required extent of precision, fine liquid drops may be jetted by just improving the method for jetting liquid drops such as by applying the hybrid method. However, to jet smaller liquid drops than those that would be jetted by the hybrid method, it is necessary to reduce the diameter of the jetting unit where a meniscus is formed.

Since the size of a liquid drop is proportionate to the diameter of the jetting unit, fine liquid drops may be jetted by reducing the diameter of the jetting unit. However, since reducing the diameter of the jetting unit requires precision processing, not only does the manufacturing cost increase, but there is also an increasing possibility that the jetting unit will be clogged up by ink particles. Further, the smaller the size of the jetting unit, the greater the electrical instability, making it difficult to jet liquid drops in consistent sizes. This serves as reason for difficulty realizing the hybrid ink jetting method even though it is a technology capable of jetting nano size liquid drops.

A purpose of the present disclosure is to solve the aforementioned problems, that is to provide an ink jetting apparatus and method capable of jetting fine liquid drops without having to reduce the diameter of the jetting unit.

According to one aspect of the present embodiment, there is provided an ink jetting apparatus including a chamber for accommodating ink and a jetting unit for jetting the ink on top of a substrate, the ink jetting apparatus including a pressurizing unit configured to form a meniscus at a tip of the jetting unit by pressurizing the ink contained in the chamber; and a vibrating unit configured to excite and decompose the meniscus formed at the tip of the jetting unit by vibrating the jetting unit.

According to another aspect of the present embodiment, there is provided an ink jetting apparatus including a chamber for accommodating ink and a jetting unit for jetting the ink on top of a substrate, the ink jetting apparatus including an electrode connected to the jetting unit, and configured to form a meniscus of a Taylor Cone shape at a tip of the jetting unit by applying a voltage to the jetting unit and generating an electric field from the jetting unit toward the substrate; and a vibrating unit configured to excite and decompose the meniscus formed at the tip of the jetting unit by vibrating the jetting unit.

According to another aspect of the present embodiment, there is provided an ink jetting method of an ink jetting apparatus including a chamber for accommodating ink and a jetting unit for jetting the ink on top of a substrate, the ink jetting method including forming a meniscus at a tip of the jetting unit; exciting and decomposing the meniscus by ultrasonically vibrating the jetting unit; and jetting fine liquid drops from the excited meniscus.

According to the present embodiment, there is an advantage that fine liquid drops may be jetted by exciting and decomposing the meniscus formed at the tip of the jetting unit using ultrasonic vibration without having to reduce the diameter of the jetting unit.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present between two elements. Like reference numerals refer to like elements throughout.

FIG. 1 is a view exemplifying a conventional ink jetting apparatus.

FIGS. 2A and 2B are views exemplifying ink being decomposed by ultrasonic vibration according to an embodiment of the present disclosure.

FIG. 3 is a view exemplifying an ink jetting apparatus according to a first embodiment of the present disclosure.

FIG. 4 is a block diagram exemplifying a control apparatus of an ink jetting apparatus according to the first embodiment of the present disclosure.

FIG. 5 is a view exemplifying the ink jetting apparatus according to the second embodiment of the present disclosure.

FIG. 6 is a block diagram exemplifying the control apparatus of the ink jetting apparatus according to the second embodiment of the present disclosure.

FIG. 7 is a view exemplifying an ink jetting apparatus according to a third embodiment of the present disclosure.

FIG. 8 is a block diagram exemplifying a control apparatus of the ink jetting apparatus according to the third embodiment of the present disclosure.

FIG. 9 is a flowchart exemplifying an ink jetting method of an ink jetting apparatus according to an embodiment of the present disclosure.

FIGS. 10A and 10B is a flowchart exemplifying viscosity and temperature of ink being controlled in the ink jetting method of the ink jetting apparatus according to the embodiment of the present disclosure.

### DETAILED DESCRIPTION

Hereinafter, an embodiment of the present disclosure will be explained in detail with reference to the exemplary drawings attached. In adding a reference numeral to each element in the drawings, it should be noted that like elements use like reference numerals if possible even if the elements are illustrated in other drawings. Further, in explaining an embodiment of the present disclosure, any specific explanation on a well-known configuration or function regarded as possibly obscuring the main point of the present disclosure will be omitted.

In explaining the elements of an embodiment of the present disclosure, reference numerals, a first, a second, i), ii), a), b) and the like, may be used. Such reference numerals are intended to distinguish those elements from other elements, not to limit the essence, turn, order and the like of the corresponding elements. In the present specification, when it is disclosed that an element ‘includes/comprises’ or ‘is provided with’ another element, it does not exclude the possibility of adding another element unless mentioned otherwise, but may further include other elements. Elements using terms such as ‘unit’, ‘module’ and the like refer to units for processing at least one function or operation, which may be embodied as ‘hardware’, ‘software’, or ‘a combination of hardware and software’.

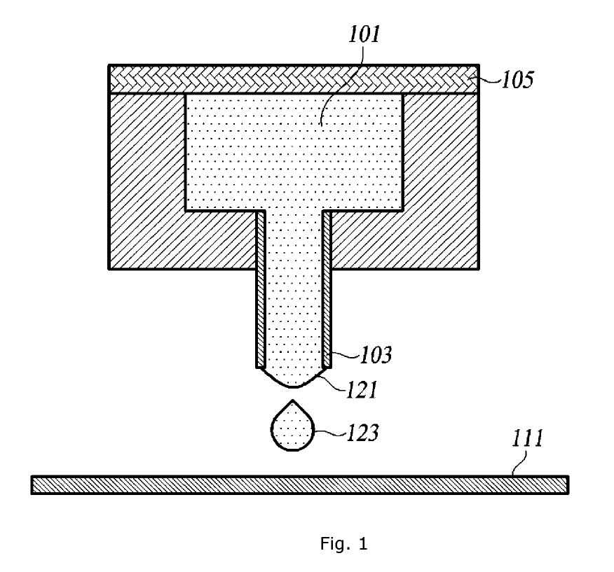

FIG. 1 is a view exemplifying a conventional ink jetting apparatus. More specifically, FIG. 1 is a view exemplifying a conventional piezoelectric type ink jetting apparatus.

The piezoelectric type ink jetting apparatus includes a chamber 101, a jetting unit 103 and a pressurizing unit 105.

The chamber 101 accommodates the ink supplied from an ink supply unit (not illustrated).

The jetting unit 103 is connected to the chamber 101 to jet the ink contained in the chamber 101 to outside.

The pressurizing unit 105 includes a piezoelectric element for pressurizing (not illustrated). When power is supplied to the piezoelectric element for pressurizing(not illustrated), the piezoelectric element for pressurizing (not illustrated) is physically transformed. As the piezoelectric element for pressurizing (not illustrated) is transformed, the ink filled in the chamber 101 is pushed towards the jetting unit 103, forming a meniscus 121 at a tip of the jetting unit 103, and accordingly, a liquid drop 123 is jetted from the meniscus 121. Here, the meniscus refers to a convex shape formed at the tip of the jetting unit 103 by surface tension of the ink.

In a conventional ink jetting apparatus, the diameter of a liquid drop being jetted is proportionate to the diameter of the meniscus, and thus in order to reduce the diameter of the meniscus, the diameter of the jetting unit must be reduced. However, reducing the diameter of the jetting unit requires precise processing, and thus not only does the manufacturing cost increase but there is also an increasing possibility that the jetting unit will clog up. Further, the smaller the size of the jetting unit, the greater the electrical instability, making it difficult to jet liquid drops in consistent sizes.

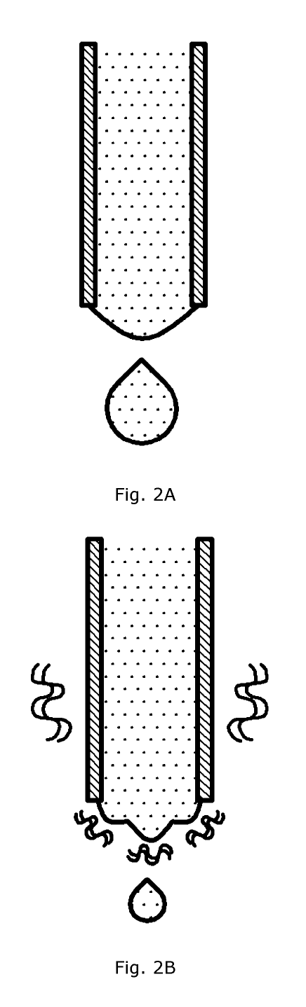

FIG. 2A and FIG. 2B are views exemplifying ink being decomposed by ultrasonic vibration according to an embodiment of the present disclosure.

Korean Patent no. 0966673 discloses a method for applying an electric field to a nozzle unit to jet liquid, and also discloses that based on a relationship between the Rayleigh limitations and voltages capable of jetting liquid, the nozzle must be 0.2 um or above, and the size of the liquid drops that may be jetted in each operation mode is limited. That is, Korean Patent no. 0966673 discloses that when using an electric field only, there are limitations to the size of the liquid drop being jetted.

In order to overcome the aforementioned limitations that occur when using the electric field only, in an embodiment of the present disclosure, a vibrating unit is installed on a surface of the jetting unit, so that vibration generated in the vibrating unit ultrasonically vibrates a liquid surface of a meniscus formed at a tip of the jetting unit, along the surface of the jetting unit. Therefore, together with the electric field, vibration energy enables liquid drops to be jetted.

An ultrasonic wave refers to vibration at a frequency higher than the audible frequency band (16˜20 k[Hz]) that may be heard by humans, that is, vibration at 20 Khz or above. An ultrasonic oscillator is an apparatus that generates ultrasonic vibration in a medium, and that uses mechanical force, hydrodynamic force, electromagnetic force, piezoelectric effect and magnetostrictive effect, etc.

An ultrasonic vibration generated in an ultrasonic oscillator is a sound wave that cannot be felt or heard by humans. It has a directional path and a very short pulse, and thus it accompanies strong vibrations. When an ultrasonic wave is applied to a medium sequentially, due to vibrations in the medium, cavitation or particle acceleration occurs in the material forming the medium, decomposing the medium into small particles or molecules. This is called dispersion action of ultrasonic waves. Ultrasonic waves include ultrasonic waves and megasonic waves, etc. An ultrasonic wave has a frequency band of 20 k to 400 k[Hz], and causes the cavitation phenomenon, decomposing a medium into small particles. A megasonic wave has a frequency band of 700 k to 1.2 M[Hz], and increases the acceleration of particles to decompose the medium into small particles.

According to Lang Formula (Lang, R. J. (1962). Ultrasonic atomization of liquids. The journal of the acoustical society of America 34:6-8), the size of a liquid drop being jetted by ultrasonic waves may be estimated such as by Formula 1 below.

$$d = 0.34 {( \frac{8 π γ}{ρ {f}^{2}} )}^{1 / 3} \qquad [ Formula 1 ]$$

In Formula 1, γ is the surface tension, ρ is the liquid density, and f is the applied frequency. This equation is based on an assumption that the capillary wavelength is ½ of the excitation frequency.

According to Formula 1, when the jetting unit is vibrated using an ultrasonic wave of approximately 1 MHz, the size of the liquid drop being jetted is approximately 4 um, which means that using ultrasonic vibrations may minimize its effects on the size of the jetting unit. That is, by concentrating an electric field on a tip of the jetting unit at the same time of applying a waveform of a certain frequency, it is possible to jet more fine and uniform liquid drops.

Formula 1 may be applied not only to ultrasonic waves but also to megasonic and surface acoustic waves. The waveforms applicable in the present disclosure include not only ultrasonic waves, but also megasonic, surface acoustic waves and the like. That is, there is no limitation to the waveform and frequency. The present specification is disclosed based on ultrasonic waves, but this is just exemplary, and thus regarding the waveform for vibrating the jetting unit, the scope of right of the present disclosure is not limited to ultrasonic waves.

FIGS. 2A and 2B compare the size of a liquid drop being jetted from a meniscus in a state where ultrasonic vibration is not applied (FIG. 2A) and the size of a liquid drop being jetted from a meniscus in a state where ultrasonic vibration is applied (FIG. 2B).

As illustrated in FIGS. 2A and 2B, when the ultrasonic oscillator generates ultrasonic vibration, the vibration is spread along the surface of the jetting unit, and vibrates the liquid surface of the meniscus formed at the tip of the jetting unit. When the liquid surface of the meniscus vibrates, cohesion between ink molecules is destroyed, and thus the ink is excited and decomposed, leading to a state where smaller liquid drops may be jetted compared to when there was no ultrasonic vibration.

### FIRST EXAMPLE

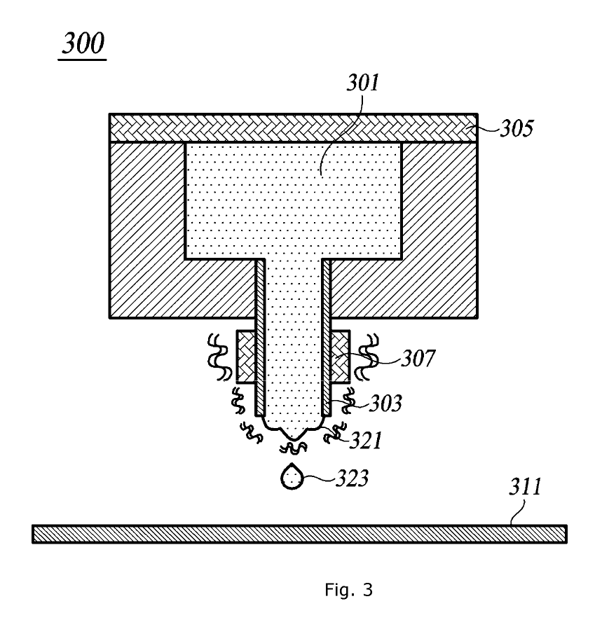

FIG. 3 is a view exemplifying an ink jetting apparatus according to a first embodiment of the present disclosure. More specifically, FIG. 3 is a view exemplifying an ink jetting apparatus where a vibrating unit for vibrating a liquid surface of a meniscus is combined with a jetting unit of a piezoelectric type ink jetting apparatus.

The ink jetting apparatus 300 according to the first embodiment of the present disclosure includes a chamber 301, a jetting unit 303, a pressurizing unit 305 and a vibrating unit 307.

The chamber 301 accommodates ink supplied from an ink supply unit (not illustrated).

The ink may be an ink for drawing a shape or for printing a color on a surface of the subject, or a conductive ink used in printing electronics. Examples of the conductive ink that may be used herein include those made by dissolving or dispersing a conductive material in a solvent, i.e., metal such as Ag, Au, Cu, Ni, Pt, Pd, Ir, Rh, W, Al and the like; metal emulsion such as Cd and Zn; oxide such as Fe, Ti, Si, Ge, Si, Zr, Ba, and the like; minute particles such as silver halide; and dispersive nano particles and the like. However, these are only exemplary and the scope of right of the present invention is not limited to the aforementioned ink materials.

The jetting unit 303 is connected to the chamber 301, and jets the ink contained in the chamber 301 on top of the substrate. Generally, the jetting unit 303 has a cylindrical shape, but it may be formed in a square pillar shape, or in a conic shape such that its diameter becomes narrower. In the present embodiment, the jetting unit 303 is illustrated as having a cylindrical shape, but this is just exemplary. The scope of right of the present disclosure is not limited to the jetting unit 303 having a cylindrical shape.

The pressurizing unit 305 pushes the ink contained in the chamber 301 to the jetting unit 303 using a piezoelectric element, electromagnetic force, pneumatic force and the like. Generally, the pressurizing unit 305 includes a piezoelectric element, and when power is applied to the piezoelectric element, the pressurizing unit pushes the ink as the plate bends by the piezoelectric effect. However, this is just exemplary, and thus the scope of right of the present invention is not limited to the pressurizing unit 305 including a piezoelectric element. The pressurizing unit may be configured to push the ink using pneumatic force instead.

The vibrating unit 307 vibrates the surface of the jetting unit 303, and the vibration spreads along the surface of the jetting unit 303 and is transmitted to a liquid surface of a meniscus 321 formed at a tip of the jetting unit 303. When the meniscus is excited by the vibration transmitted to the liquid surface of the meniscus 321, there comes a state where fine liquid drops 323 may be easily jetted from the meniscus 321.

The vibrating unit 307 includes an ultrasonic oscillator (not illustrated). The ultrasonic oscillator (not illustrated) is an apparatus that generates ultrasonic vibration in a medium. The ultrasonic oscillator may be configured in various designs, using mechanical force, hydrodynamic force, electromagnetic force, piezoelectric effect and magnetostrictive effect, etc. However, considering designing an ultrasonic oscillator that has a small size and drives at low power, it is desirable to use an ultrasonic oscillator that uses the piezoelectric effect. Examples of the piezoelectric element that can provide the piezoelectric effect include various materials such as crystal vibrator, Rochelle salt vibrator, barium titanate (BaTiO₃) vibrator, PZT(Pb—Zi—Ti) vibrator, langevin vibrator, nickel vibrator, ferrite vibrator and the like. Further, an ultrasonic oscillator that synchronizes with a single frequency may also be used, but for a more precise control, it is desirable to use an ultrasonic oscillator that electrically vibrates in synchronization to two or more frequencies.

The vibrating unit 307 may be designed to cover overall areas of the jetting unit 303 or to be attached to one side of the jetting unit 303 in a suitable shape to the jetting unit 303. For example, if the jetting unit 303 has a cylindrical shape, the vibrating unit 307 may be designed in a cylindrical shape that covers the overall areas of the jetting unit 303, and then attached to cover the overall areas of the jetting unit. Otherwise, the vibrating unit 307 may be designed in a rectangular shape that is bent, and then attached to one side of the jetting unit 303. Otherwise, the vibrating unit 307 may also be designed to be attached to an inner wall of the chamber 301.

FIG. 3 illustrates that a vibrating unit 307 having a cylindrical shape is integrally combined at a lower portion of the jetting unit 303, but this is just exemplary, and thus the scope of right of the present disclosure is not limited to the vibrating unit 307 being integrally combined at the lower portion of the jetting unit 303. Instead of being integrally combined with the jetting unit 303, the vibrating unit 307 may be positioned at a distance short enough from the jetting unit 303 in order to vibrate the jetting unit 303 using vibration of the vibrating unit 307, and one skilled in the related art should be able to modify and/or adjust the position of the vibrating unit 307 to various positions within the scope of essential characteristics of the present disclosure.

When the vibrating unit 307 generates ultrasonic vibration, the ultrasonic vibration is spread along the surface of the jetting unit 303, and then transmitted to the liquid surface of the meniscus 321 formed at the tip of the jetting unit 303, thereby turning the meniscus 321 into a state where fine liquid drops 323 may be easily jetted. Here, it is desirable that the jetting unit 303 is made of a metal material having good durability and excellent vibration dispersiveness such as titanium, so that the vibration generated in the vibrating unit 307 may be well-delivered to the liquid surface of the meniscus 321 along the surface of the jetting unit 303. Otherwise, it is possible to make the jetting unit 303 with an insulator, and coat its surface with a metal material having good durability and excellent vibration dispersiveness.

FIG. 4 is a block diagram exemplifying a control apparatus of an ink jetting apparatus according to a first embodiment of the present disclosure. FIG. 4 illustrates that the control apparatus of the ink jetting apparatus according to the first embodiment is configured separately from the ink jetting apparatus, but the control apparatus of the ink jetting apparatus according to the first embodiment may be configured integrally with the ink jetting apparatus.

The control apparatus 400 of the ink jetting apparatus according to the first embodiment includes a control unit 401, a first power supply unit 411, and a second power supply unit 421.

The first power supply unit 411 supplies power to the pressurizing unit 305, and the second power supply unit 421 supplies power to the vibrating unit 307.

The control unit 401 may control the power that the first power supply unit 411 supplies to the pressurizing unit 305, and the power that the second power supply 421 supplies to the vibrating unit 307 according to the size of the liquid drops 323 to be jetted. For example, the control unit 401 may control the amplitude, frequency, power application duration of the power and the like.

The control apparatus 400 of the ink jetting apparatus according to the first embodiment of the present disclosure may further include a sensor unit 403. The sensor unit 403 may be a viscosity sensor that measures the viscosity of the ink inside the chamber 303 or a temperature sensor that measures the temperature of the ink inside the chamber 303.

If the viscosity of the ink is higher than a predetermined reference viscosity, the meniscus 321 will not be excited well than it would be otherwise. Therefore, the control unit 401 may increase the amplitude, the frequency, or the application duration of the power being supplied by the second power supply unit 421, thereby exciting the meniscus 321 to the extent necessary for jetting liquid drops 323 of a wanted size. That is, in jetting liquid drops 323 of a same size, if the viscosity of the ink is higher than the reference viscosity, the amplitude, the frequency, or the application duration of the power being supplied by the second power supply unit 421 may be controlled to be greater than the amplitude, the frequency, or the power application duration of the power that would be applied in order to jet liquid drops 323 of a same size for the ink having the reference viscosity.

On the contrary, if the viscosity of the ink is lower than the predetermined reference viscosity, the meniscus 321 will be easily excited than it would be otherwise. Therefore, the control unit 401 may reduce the amplitude, the frequency, or the application duration of the power being supplied by the second power supply unit 421, thereby exciting the meniscus 321 to the extent necessary for jetting liquid drops 323 of a wanted size. That is, in jetting liquid drops 323 of a same size, if the viscosity of the ink is lower than the reference viscosity, the amplitude, the frequency, or the application duration of the power being supplied by the second power supply unit 421 may be controlled to be smaller than the amplitude, the frequency, or the power application duration of the power that would be applied in order to jet liquid drops 323 of a same size for the ink having the reference viscosity.

Meanwhile, if the temperature of the ink is higher than a predetermined reference temperature, an increase of temperature of a liquid decreases the viscosity of the liquid and thus the meniscus is excited more easily than would be otherwise. Therefore, the control unit 401 may reduce the amplitude, the frequency, or the application duration of the power being supplied by the second power supply unit 421, thereby exciting the meniscus 321 to the extent necessary for jetting liquid drops 323 of a wanted size. That is, in jetting liquid drops 232 of a same size, if the temperature of the ink is higher than the reference temperature, the amplitude, the frequency, or the application duration of the power being supplied by the second power supply unit 421 may be controlled to be smaller than the amplitude, the frequency, or the application duration of the power that would be applied in order to jet liquid drops 323 of a same size at the reference temperature.

On the contrary, if the temperature of the liquid is lower than the predetermined reference temperature, a decrease of temperature of a liquid increases the viscosity of the liquid and thus, the meniscus 321 is not excited well than would be otherwise. Therefore, the control unit 401 may increase the amplitude, the frequency, the application duration of the power being supplied by the second power supply unit 421, thereby exciting the meniscus 321 to the extent necessary for jetting liquid drops 323 of a wanted size. That is, in jetting liquid drops 323 of a same size, if the temperature of the ink is lower than the reference temperature, the amplitude, the frequency, or the application duration of the power being supplied by the second power supply unit 421 may be controlled to be greater than the amplitude, the frequency, or the application duration of the power that would be applied in order to jet liquid drops 323 of a same size at the reference temperature.

### SECOND EXAMPLE

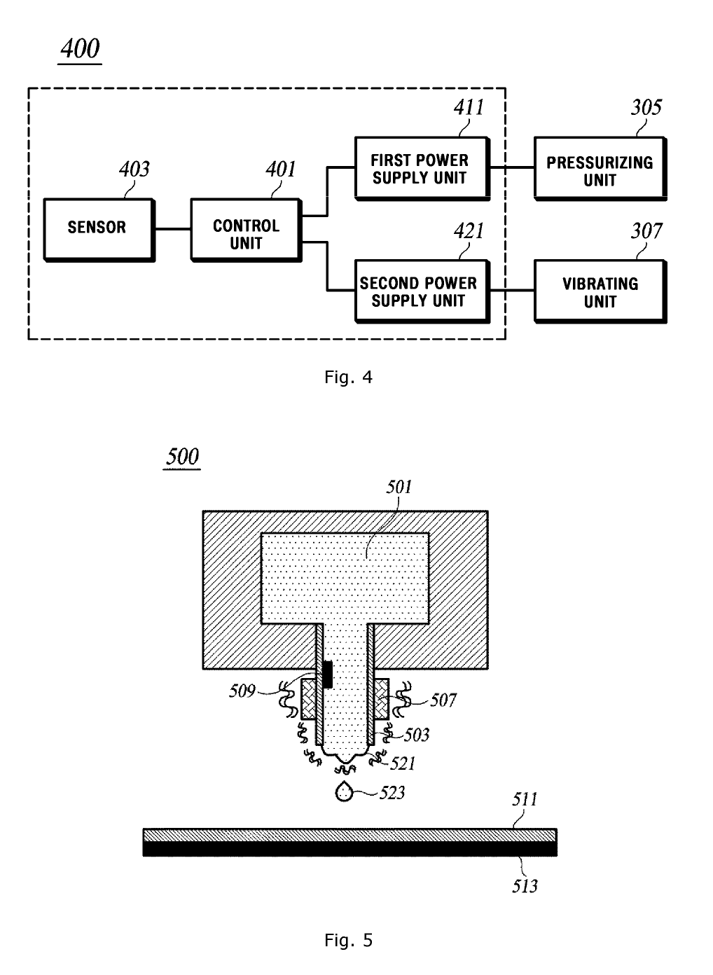

FIG. 5 is a view exemplifying an ink jetting apparatus according to a second embodiment of the present disclosure. More specifically, FIG. 5 is a view exemplifying an ink jetting apparatus where a vibrating unit for ultrasonically vibrating a meniscus is combined with a jetting unit of an Electro-Hydro-Dynamic (EHD) type ink jetting apparatus.

The ink jetting apparatus 500 according to a second embodiment of the present disclosure includes a chamber 501, a jetting unit 503, a vibrating unit 507, and a first electrode 509. At a lower portion of a substrate 511, a second electrode 513 is disposed.

The chamber 501 accommodates ink supplied from an ink supply unit (not illustrated).

The jetting unit 503 is connected to the chamber 501 to jet the ink contained in the chamber 501 on the top of the substrate 511.

Voltages of opposite polarities may be applied to the first electrode 509 and the second electrode 511, respectively. When the voltages of opposite polarities are applied to the first electrode 509 and the second electrode 511, respectively, an electric field may be formed from the jetting unit 503 toward the substrate 511, and at the same time, charges may be concentrated on a liquid surface of the meniscus 521. If the charges generated on the liquid surface of the meniscus 521 and the pressure at which liquid drops 523 would be jetted from the meniscus by the electric field become greater than the surface tension of the meniscus 521, the spherical meniscus 521 will turn into a so-called Taylor Cone shape of 49.3°, so that liquid drops of a much smaller size than the jetting unit 511 may be jetted.

When using an electrostatic method, as Taylor Cones may be formed by an electric field, liquid drops of hundreds of nm to several μm size liquid drops may be jetted from a nozzle of tens of μm to hundreds of μm, thereby providing advantages of increased line width resolution and improved linearity of the liquid drops being jetted.

The vibrating unit 507 vibrates a surface of the jetting unit 503, and the vibration spreads along the surface of the jetting unit 503 and is transmitted a liquid surface of a meniscus 521 formed at a tip of the jetting unit 503. When the meniscus 521 is excited and decomposed by the vibration transmitted to the liquid surface of the meniscus 521, the meniscus 521 turns into a state where fine liquid drops 523 may be easily jetted therefrom.

Type of the ink, material of the jetting unit 503, location and configuration of the vibrating unit 507 are almost the same as those of the first embodiment mentioned above, and thus repeated explanation will be omitted.

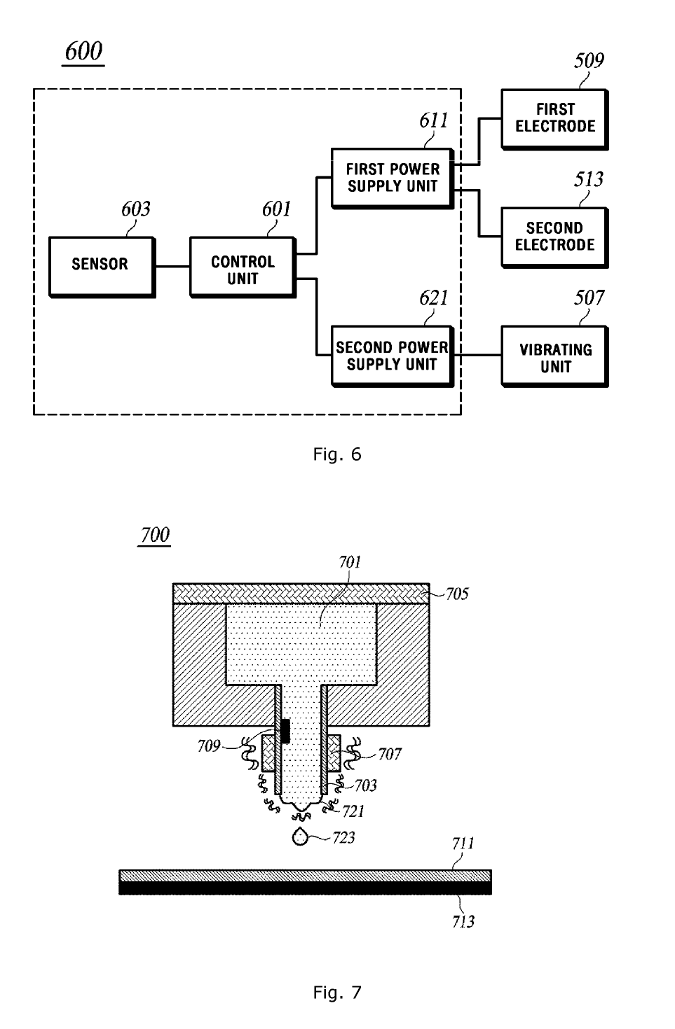

FIG. 6 is a block diagram exemplifying the control apparatus of the ink jetting apparatus according to the second embodiment of the present disclosure. Although FIG. 6 illustrates that the control apparatus of the ink jetting apparatus according to the second embodiment is configured separately from the ink jetting apparatus, the control apparatus of the ink jetting apparatus according to the second embodiment may be configured integrally with the ink jetting apparatus instead.

The control apparatus 600 of the ink jetting apparatus according to the second embodiment of the present disclosure includes a control unit 601, a first power supply unit 611, and a second power supply unit 621.

The first power supply unit 611 supplies power of opposite polarities to the first electrode 509 and the second electrode 513, and the second power supply unit 621 supplies power to the vibrating unit 507.

The control unit 601 may control the power that the first power supply unit 611 supplies to the first electrode 509 and the second electrode 513 and the power that the second power supply unit 621 supplies to the vibrating unit 507 according to the size of the liquid drops 523 to be jetted. For example, the control unit 401 may control the amplitude, the frequency, and the application duration of the power.

The control apparatus 600 of the ink jetting apparatus according to the second embodiment of the present disclosure may further include a sensor unit 603. The sensor unit 603 may be a viscosity sensor that measures the viscosity of the ink in the chamber 503, or a temperature sensor that measures the temperature of the ink.

The method for controlling the power that the second power supply unit 621 supplies to the vibrating unit 507 according to the viscosity or temperature of the ink is almost the same as that of the first embodiment, and thus repeated explanation will be omitted.

### THIRD EXAMPLE

FIG. 7 is a view exemplifying an ink jetting apparatus according to a third embodiment of the present disclosure. More specifically, FIG. 5 is a view exemplifying an ink jetting apparatus where a vibrating unit for ultrasonically vibrating a meniscus is combined with a jetting unit of a hybrid type ink jetting apparatus, the hybrid type ink jetting apparatus being a combination of the piezoelectric method and the Electro-Hydro Dynamic (EHD) method.

The ink jetting apparatus 700 according to the third embodiment of the present disclosure includes a chamber 701, a jetting unit 703, a vibrating unit 707, and a first electrode 709. At a lower portion of a substrate 711, a second electrode 713 is disposed.

The chamber 701 accommodates ink supplied from an ink supply unit (not illustrated).

The jetting unit 703 is connected to the chamber 701 to jet the ink contained in the chamber 701 on the top of the substrate 711.

The pressurizing unit 705 pushes the ink contained in the chamber 701 using a piezoelectric element, electromagnetic force, pneumatic force and the like. Generally, the pressurizing unit 705 includes a piezoelectric element, and when power is applied to the piezoelectric element, the pressurizing unit pushes the ink as the plate bends by the piezoelectric effect. However, this is just exemplary, and thus the scope of right of the present invention is not limited to the pressurizing unit 705 including a piezoelectric element. The pressurizing unit may be configured to push the ink using pneumatic force instead.

To the first electrode 709 and the second electrode 711, voltages of mutually opposite polarities may be applied. When such voltages of opposite polarities are applied to the first electrode and to the second electrode 711, an electric field is formed from the jetting unit 703 toward the substrate 711, and the meniscus 721 that used to have a spherical shape changes into a Taylor Cone shape, and jets the liquid drops 723.

Generally, in the hybrid method, the pressurizing unit 705 plays a role of controlling the liquid surface of the meniscus 721, and the electric field generated by the first electrode 709 and the second electrode 711 plays a role of jetting liquid drops of a fine size from the liquid surface of the meniscus 721. However, depending on the designing method, the electric field may be configured to control the liquid surface of the meniscus 721, and the pressurizing unit 705 may be configured to jet liquid drops of a fine size from the liquid surface of the meniscus 721.

The vibrating unit 707 vibrates the surface of the jetting unit 703, and the vibration spreads along the surface of the jetting unit 703 and is transmitted to the liquid surface of the meniscus 721 formed at a tip of the jetting unit 703. When the meniscus 721 is excited and decomposed by the vibration transmitted to the liquid surface of the meniscus 721, the meniscus 721 turns into a state where fine liquid drops 723 may be easily jetted.

Type of the ink, material of the jetting unit 703, location and configuration of the vibrating unit 707 are almost the same as those of the first embodiment mentioned above, and thus repeated explanation will be omitted.

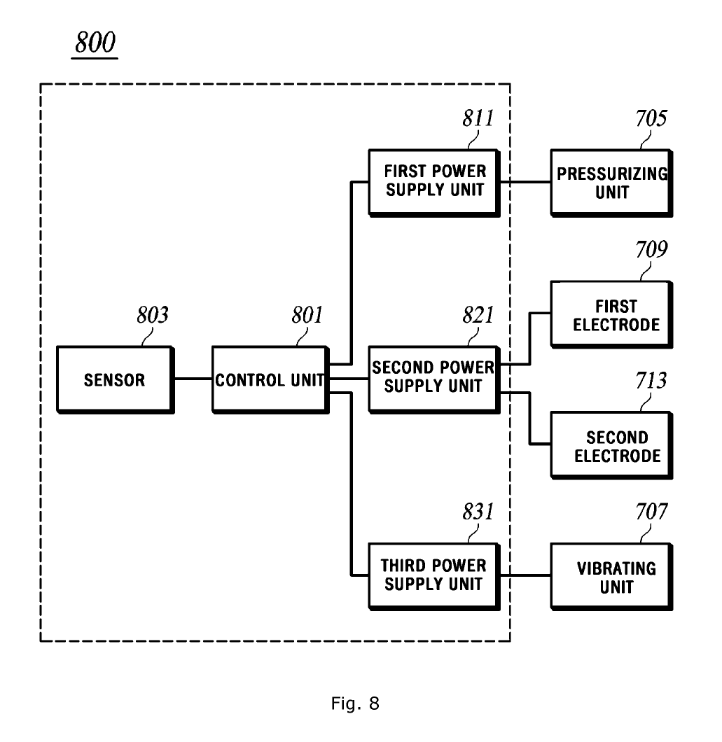

FIG. 8 is a block diagram exemplifying a control apparatus of the ink jetting apparatus according to the third embodiment of the present disclosure. FIG. 8 illustrates that the control apparatus of the ink jetting apparatus according to the third embodiment is configured separately from the ink jetting apparatus, but the control apparatus of the ink jetting apparatus according to the third embodiment may be configured integrally with the ink jetting apparatus.

The control apparatus 800 of the ink jetting apparatus according to the third embodiment of the present disclosure includes a control unit 801, a first power supply unit 811, a second power supply unit 821, and a third power supply unit 831.

The first power supply unit 811 supplies power to the pressurizing unit 705, and the second power supply unit 821 supplies power of opposite polarities to the first electrode 709 and the second electrode 713, and the third power supply unit 831 supplies power to the vibrating unit 707.

The control unit 801 may control the power that the first power supply unit 811 supplies to the pressurizing unit 705, the power that the second power supply unit 821 supplies to the first electrode 709 and to the second electrode 713, and the power that the third power supply unit 831 supplies to the vibrating unit 707 according to the size of the liquid drops 723 to be jetted. For example, the control unit 801 may control the amplitude, the frequency, the application duration of the power and the like.

The control apparatus 800 of the ink jetting apparatus according to the third embodiment of the present disclosure may further include a sensor unit 803. The sensor unit 803 may be a viscosity sensor that measures the viscosity of the ink in the chamber 703 or a temperature sensor that measures the temperature of the ink.

The method for controlling the power that the third power supply unit 831 supplies to the vibrating unit 707 according to the viscosity or temperature of ink is almost the same as the method according to the first embodiment, and thus repeated explanation will be omitted.

Ink Jetting Method

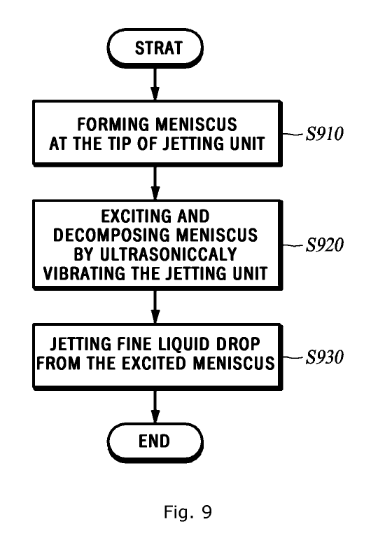

FIG. 9 is a flowchart exemplifying the ink jetting method of the ink jetting apparatus according to an embodiment of the present disclosure.

The ink jetting method according to an embodiment of the present disclosure includes a step of forming a meniscus (S910), a step of decomposing the meniscus (S920), and a step of jetting a liquid drop (S930).

The step of forming a meniscus (S910) is a step of forming the meniscus at a tip of the jetting unit by pressurizing the ink in the chamber or using electrostatic force between the jetting unit and the substrate. In pressurizing the ink, the piezoelectric effect of the piezoelectric element, pneumatic pressure, or an actuator may be used, or the ink may be pressurized in various methods.

The step of decomposing the meniscus (S920) is a step of exciting and decomposing the meniscus as the vibrating unit vibrates a surface of the jetting unit and the vibration spreads along a surface of the jetting unit and then is transmitted to a liquid surface of the meniscus formed at a tip of the jetting unit. In vibrating the surface of the jetting unit, a method for ultrasonically vibrating a vibrating unit that is integrally combined with the jetting unit or a vibrating unit positioned at distance short enough to vibrate the jetting may be used.

The step of jetting a liquid drop (S930) is a step of jetting a fine liquid drop from the excited meniscus. In jetting the liquid drop, the intensity of the vibration being transmitted to the liquid surface of the meniscus may be adjusted so that the liquid drop is jetted by the vibration, or the liquid drop may be jetted through additional pressure (in the case of a piezoelectric type ink jetting apparatus) or additional application of electrostatic force (in the case of an electrostatic ink jetting apparatus).

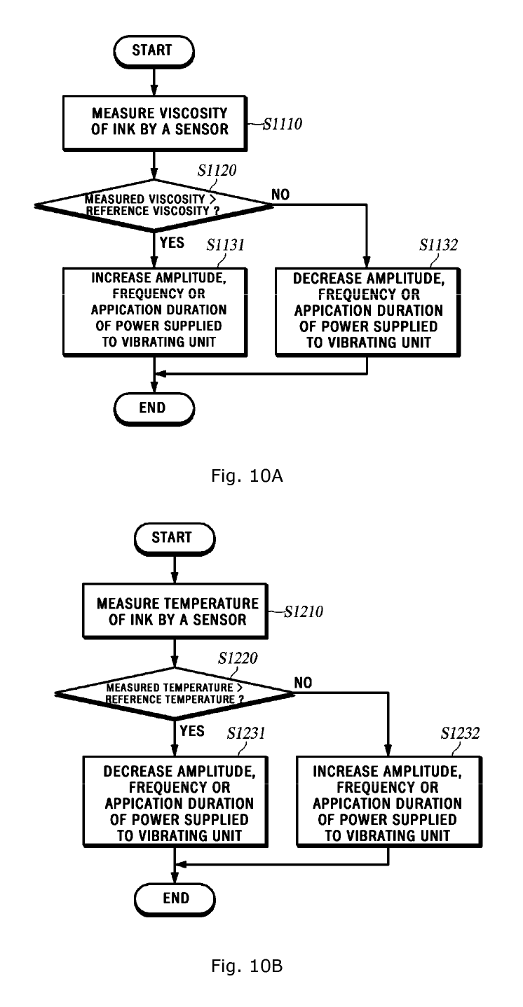

FIGS. 10A and 10B are flowcharts exemplifying viscosity and temperature of ink being controlled in the ink jetting method of the ink jetting apparatus according to the embodiment of the present disclosure.

FIG. 10A exemplifies a method for controlling the ink jetting apparatus according to an embodiment of the present disclosure according to the viscosity of the ink.

First of all, the viscosity of the ink is measured at the sensor unit (S1110).

Next, the measured viscosity is compared to a predetermined reference viscosity (S1120).

If the measured viscosity is higher than the predetermined reference viscosity, the meniscus will not be excited well than it would be otherwise, and thus by increasing the amplitude, the frequency, or the application duration of the power being supplied to the vibrating unit for performing ultrasonic vibration, the meniscus may be excited to the extent necessary for jetting the liquid drop of a wanted size (S1131).

On the contrary, if the measured viscosity is lower than the predetermined reference viscosity, the meniscus will be easily excited than it would be otherwise, and thus by decreasing the amplitude, the frequency, or the application duration of the power being supplied to the vibrating unit for performing ultrasonic vibration, the meniscus may be excited to the extent necessary for jetting the liquid drop of a wanted size (S1132).

FIG. 10B is a view exemplifying a method for controlling the ink jetting apparatus according to an embodiment of the present disclosure according to the temperature of the ink.

First of all, the temperature of the ink is measured at the sensor unit (S1210).

Next, the measured temperature is compared to a predetermined reference temperature (S1220).

If the measured temperature is higher than the predetermined reference temperature, an increase of temperature of a liquid decreases the viscosity of the liquid, thereby exciting the meniscus more easily than would be otherwise. Therefore, by decreasing the amplitude, the frequency, or the application duration of the power being supplied to the vibrating unit for performing ultrasonic vibration, the meniscus may be excited to the extent necessary for jetting the liquid drop of a wanted size (S1231).

On the contrary, if the temperature of the liquid is lower than the predetermined reference temperature, a decrease of temperature of a liquid increases the viscosity of the liquid and thus, the meniscus is not excited well than would be otherwise. Therefore, by increasing the amplitude, the frequency, or the application duration of the power being supplied to the vibrating unit for performing ultrasonic vibration, the meniscus may be excited to the extent necessary for jetting the liquid drop of a wanted size (S1232).

In the drawings and specification, there have been disclosed typical embodiments of the invention, and although specific terms are employed, they are used in a generic and descriptive sense only and not for purposes of limitation. It will be understood by those of ordinary skill in the art that various changes in form and details may be made therein without departing from the spirit and scope of the present invention as defined by the following claims.

What is claimed is:

1. An ink jetting apparatus including a chamber for accommodating ink and a jetting unit for jetting the ink on a top of a substrate, the ink jetting apparatus comprising:
a pressurizing unit configured to form a meniscus at a tip of the jetting unit by pressurizing the ink contained in the chamber; and
a vibrating unit configured to excite and decompose the meniscus formed at the tip of the jetting unit by vibrating the jetting unit.

2. The ink jetting apparatus according to claim 1,
wherein the jetting unit is made of a metal material.

3. The ink jetting apparatus according to claim 1,
wherein the jetting unit is an insulator, and a surface of the jetting unit is coated with a metal material.

4. The ink jetting apparatus according to claim 1,
further comprising:
a sensor unit configured to measure a viscosity of the ink;
a first power supply unit configured to supply power to the pressurizing unit;
a second power supply unit configured to supply power to the vibrating unit; and
a control unit configured to control at least one of an amplitude, a frequency, and an application duration of the power which is supplied by the second power supply unit, according to the viscosity of the ink.

5. The ink jetting apparatus according to claim 1,
further comprising:
a sensor unit configured to measure a temperature of the ink;
a first power supply unit configured to supply power to the pressurizing unit;
a second power supply unit configured to supply power to the vibrating unit; and
a control unit configured to control at least one of an amplitude, a frequency, and an application duration of the power which is supplied by the second power supply unit, according to the temperature of the ink.

6. An ink jetting apparatus including a chamber for accommodating ink and a jetting unit for jetting the ink on top of a substrate, the ink jetting apparatus comprising:
an electrode connected to the jetting unit, and configured to form a meniscus of a Taylor Cone shape at a tip of the jetting unit by applying a voltage to the jetting unit and generating an electric field from the jetting unit toward the substrate; and
a vibrating unit configured to excite and decompose the meniscus formed at the tip of the jetting unit by vibrating the jetting unit.

7. The ink jetting apparatus according to claim 6,
wherein the jetting unit is made of a metal material.

8. The ink jetting apparatus according to claim 6,
wherein the jetting unit is an insulator, and a surface of the jetting unit is coated with a metal material.

9. The ink jetting apparatus according to claim 6,
further comprising:
a sensor unit configured to measure a viscosity of the ink;
a first power supply unit configured to supply power to the electrode;
a second power supply unit configured to supply power to the vibrating unit; and
a control unit configured to control at least one of an amplitude, a frequency, and an application duration of the power which is supplied by the second power supply unit, according to the viscosity of the ink.

10. The ink jetting apparatus according to claim 6,
further comprising:
a sensor unit configured to measure a viscosity of the ink;
a first power supply unit configured to supply power to the electrode;
a second power supply unit configured to supply power to the vibrating unit; and
a control unit configured to control at least one of an amplitude, a frequency, and an application duration of the power being supplied by the second power supply unit, according to the temperature of the ink.

11. An ink jetting method of an ink jetting apparatus including a chamber for accommodating ink and a jetting unit for jetting the ink on a top of a substrate, the ink jetting method comprising:
forming a meniscus at a tip of the jetting unit;
exciting and decomposing the meniscus by ultrasonically vibrating the jetting unit; and
jetting fine liquid drops from the excited meniscus.

12. The ink jetting method according to claim 11,
wherein the decomposing comprises:
measuring a viscosity of the ink; and
controlling at least one of an intensity, a cycle, and a vibration duration of the ultrasonic vibration according to the viscosity of the ink.

13. The ink jetting method according to claim 11,
wherein the decomposing comprises:
measuring a temperature of the ink; and
controlling at least one of an intensity, a cycle, and a vibration duration of the ultrasonic vibration according to the temperature of the ink.
